(19) United States
(12) Patent Application Publication
(10) Pub. No.: US 2018/0314519 A1
(43) Pub. Date: Nov. 1, 2018

(54) METHOD AND APPARATUS FOR ANALYZING IMPACT OF SOFTWARE CHANGE

(71) Applicants: HYUNDAI MOTOR COMPANY, Seoul (KR); KIA MOTORS CORPORATION, Seoul (KR)

(72) Inventors: Si Hyun LEE, Seongnam-si (KR); Se Young PARK, Hwaseong-si (KR)

(21) Appl. No.: 15/822,805

(22) Filed: Nov. 27, 2017

(30) Foreign Application Priority Data
Apr. 26, 2017 (KR) 10-2017-0053498

(51) Int. Cl. G06F 9/44; G06F 9/45; G06F 11/36

(52) U.S. Cl. CPC G06F 8/71; G06F 11/3692; G06F 11/3616; G06F 8/433

(57) ABSTRACT

Disclosed herein is a method for analysis of change in software including inputting data containing two different source codes, analyzing the input data by a change type based on a database schema including syntax information, and outputting an analysis result for each change type.

An apparatus for analyzing impact of change in software includes an input unit configured to input data containing two different source codes, a software change impact analyzer configured to analyze the input data by a change type based on a database schema including syntax information, and a report generation unit configured to outputting an analysis result for each change type.

This application claims the benefit of priority under 35 U.S.C. § 119 to Korean Patent Application No. 10-2017-0053498, filed on Apr. 26, 2017 in the Korean Intellectual Property Office, which is hereby incorporated by reference as if fully set forth herein.

### TECHNICAL FIELD

The present disclosure relates to a method and apparatus for analyzing impact of software change, and more particularly, to a method and apparatus for analyzing impact of software change that extract a part changed when the software is modified, and analyze the parts directly and indirectly influenced by the changed part such that corresponding portions may be evaluated.

### BACKGROUND

Conventional technology requires various testing techniques to secure reliability of embedded software, which becomes increasingly complicated due to increase in requirements from users. In particular, it is desirable to select an efficient regression testing technique that ensures that the changes meet the requirements in modifying the software. However, as software becomes more complicated, even a small change in one module may affect several modules. Accordingly, when there is any small change in the software, the whole system is often subjected to total inspection. In this case, evaluation efficiency can be deteriorated as even parts irrelevant to changes to the software are re-evaluated.

In particular, there are cases where the existing software evaluates only the changed items. In such cases, a functional error irrespective of the software improvement may be generated.

### SUMMARY

Accordingly, the present disclosure is directed to a method and apparatus for analyzing impact of software change that substantially obviate one or more problems due to limitations and disadvantages of the related art.

An object of the present disclosure is to provide a method and apparatus for analyzing impact of software change which are capable of extracting a part changed when the software is modified and analyzing the parts directly and indirectly impacted by the changed part such that corresponding parts may be evaluated.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

In an aspect of the present disclosure, a method for analyzing impact of software change may include inputting data containing two different source codes, analyzing the input data by a change type based on a database schema including syntax information, and outputting an analysis result for each change type.

In another aspect of the present disclosure, an apparatus for software change impact analysis may include an input unit configured to input data containing two different source codes, a software change impact analyzer configured to analyze the input data by a change type based on a database schema including syntax information, and a report generation unit configured to outputting an analysis result for each change type.

It is to be understood that both the foregoing general description and the following detailed description of the present disclosure are exemplary and explanatory and are intended to provide further explanation of the disclosure as claimed.

### BRIEF DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram illustrating an apparatus for software change impact analysis according to an embodiment of the present disclosure.

FIG. 2 is an exemplary diagram illustrating a database schema including syntax information according to an embodiment of the present disclosure.

FIG. 3 is an exemplary diagram illustrating a method for software change impact analysis.

FIG. 4 is a flowchart illustrating change impact analysis for each type of change according to an embodiment of the present disclosure.

FIG. 5 is an exemplary diagram illustrating change impact analysis for a data flow according to an embodiment of the present disclosure.

FIG. 6 is a flowchart illustrating an analysis execution procedure of a software change impact analyzer according to an embodiment of the present disclosure;

FIG. 7 is a flowchart illustrating a software change impact analysis output according to an embodiment of the present disclosure.

FIG. 8 is an exemplary diagram illustrating an evaluation item matching unit of a software change impact analyzer according to an embodiment of the present disclosure.

FIG. 9 is an exemplary diagram illustrating an analysis execution procedure of a software change impact analyzer according to an embodiment of the present disclosure.

FIG. 10 is an exemplary diagram illustrating a flow of software change impact analysis according to an embodiment of the present disclosure.

FIG. 11 is an exemplary diagram illustrating a flow of evaluation item matching according to an embodiment of the present disclosure.

### DETAILED DESCRIPTION

Reference will now be made in detail to embodiments of the present disclosure, examples of which are illustrated in the accompanying drawings. Wherever possible, the same reference numbers will be used throughout the drawings to refer to the same or like parts. As used herein, the suffixes “module” and “unit” are added or used interchangeably to simply facilitate preparation of this specification and are not intended to suggest meanings or functions distinguished therebetween.

In the description of embodiments, it will be understood that when a component is referred to as being formed ‘on (over)’ or ‘under (below)’ and ‘in front of (before)’ or ‘after (behind)’ another component, ‘on (over)’ or ‘under (below)’ and ‘in front of (before)’ or ‘after (behind)’ include both the meanings of ‘directly’ and ‘indirectly’.

In describing the components of the present disclosure, terms such as first, second, A, B, (a), and (b) may be used. These terms are used only for the purpose of distinguishing one constituent from another, and the terms do not limit the nature, order or sequence of the components. When one component is said to be “connected,” “coupled” or “linked” to another, it should be understood that this means the one component may be directly connected or linked to another one or another component may be interposed between the components.

The term “include,” “comprise” or “have” should be understood as not precluding the possibility of existence or addition of one or more other components unless otherwise stated. All terms, including technical and scientific terms, have the same meaning as commonly understood by one of ordinary skill in the art to which this disclosure pertains, unless otherwise defined. Commonly used terms, such as those defined in typical dictionaries, should be interpreted as being consistent with the contextual meaning of the relevant art, and are not to be construed in an ideal or overly formal sense unless expressly defined to the contrary.

Embodiments of the present disclosure relate to a method and apparatus for analysis of software change point and impact of the change that extract a portion changed when the software is modified, and analyze even the portions indirectly influenced by the change portion although not directly changed, such that only the directly and indirectly affected portions may be evaluated.

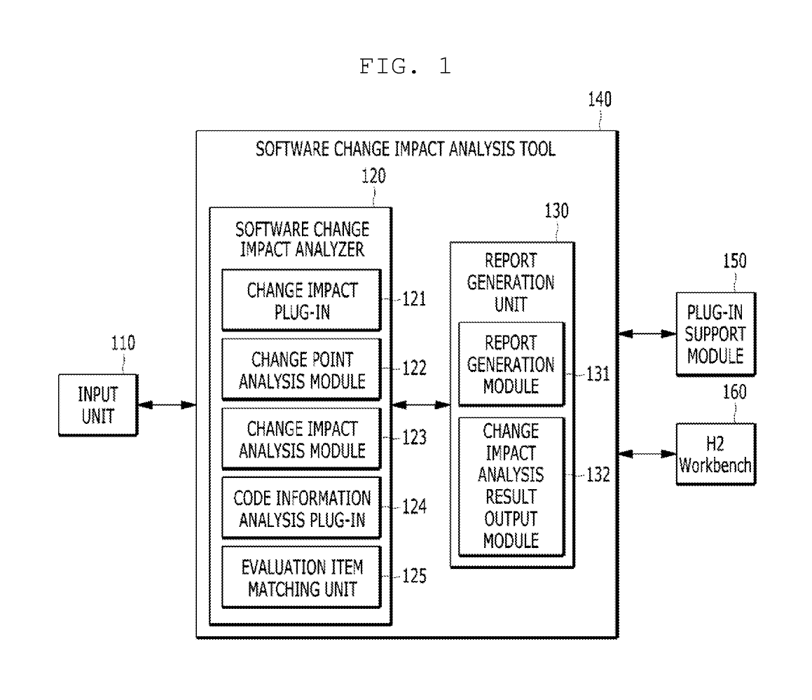

FIG. 1 is a block diagram illustrating an apparatus for analyzing impact of software change, according to an embodiment of the present disclosure.

Referring to FIG. 1, an impact analysis apparatus 100 for analyzing impact of software change includes an input unit 110, a software change impact analyzer 120, a report generation unit 130, a software change impact analysis tool 140, a plug-in support module 150, and an H2 workbench 160.

Data including two different source codes may be input through the input unit 110.

The input unit 110 may receive input data including source code of a previous version and a current version.

The input data may be analyzed according to a type of change based on a database schema including a syntax information.

The database schema is an architecture in which a structure of data, a method of expressing data, and a relation between data are defined in a format language in a database. The database management system creates a database schema according to given settings. When a user of the database stores, queries, deletes, or changes the data, the database management system executes the command, referring to the database schema.

The database schema may include basic semantic information about a program.

The software change impact analyzer 120 includes a change impact plug-in 121, a change point analysis module 122, a change impact analysis module 123, a code information analysis plug-in 124 and an evaluation item matching unit 125.

The software change impact analyzer 120 may analyze the change impact according to the data flow, the control flow or definition and declaration of data types.

The change impact analysis plug-in 121 may analyze the impact of a line deleted or changed after a change in a previous version of code is received from the input unit 110.

The change point analysis module 122 may map the previous version of the change impact line to the current version. As used herein, change impact line means lines in a previous version programs affected directly or indirectly by a program change.

The change impact analysis module 123 may analyze the impact of the previous version of impact line and a line added or changed in the current version.

The change impact analysis module 123 may further analyze a function employing the change impact line and impact of changing a global variable.

The global variable may be a variable that takes all modules in a program as valid regions of variable declaration and is accessible anywhere in the given program.

The change impact analysis module 123 may classify a result of the analysis into an analysis object including at least one of a variable, a function, a file, and a line.

The change impact analysis module 123 may classify the change into a change analysis item including at least one of direct change, indirect change, and no impact based on the classified analyzer, and output the classified item.

The code information analysis plug-in 124 may include a symbol database extraction module. The symbol database extraction module may analyze and store semantic information and syntax information about the program.

The evaluation item matching unit 125 may analyze an item that needs to be re-evaluated, based on the result of analysis of impact of software change.

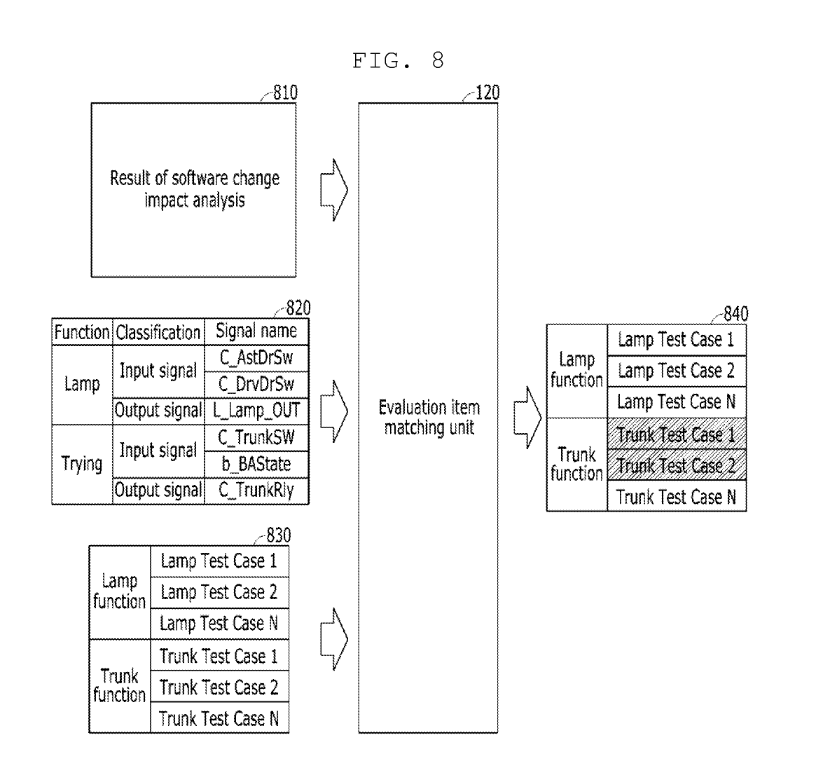

The evaluation item matching unit 125 may analyze the result of software analysis, a function-specific input/output list 820 (see FIG. 8) and an evaluation item list 830 (see FIG. 8) as input data and extract an evaluation item 840 that need to be re-evaluated.

The report generation unit 130 may include a report generation module 131 and a change impact analysis result output module 132.

The report generation module 131 may generate a report from the result of analysis received from the software change impact analyzer 120.

The change impact analysis result output module 132 may output the report received from the report generation module 131.

The report generation unit 130 may display the result of analysis of the impact of software change.

The report generation unit 130 may output the result of analysis of the impact of software change to the evaluation item matching unit 125.

The software change impact analysis tool 140 may include the software change impact analyzer 120 and the report generation unit 130.

The plug-in support module 150 may support various analyses and plug-ins of the software impact analysis tool 140.

The H2 workbench 160 may provide a user interface.

The H2 workbench 160 may output the result of analysis of the software impact analysis tool 140.

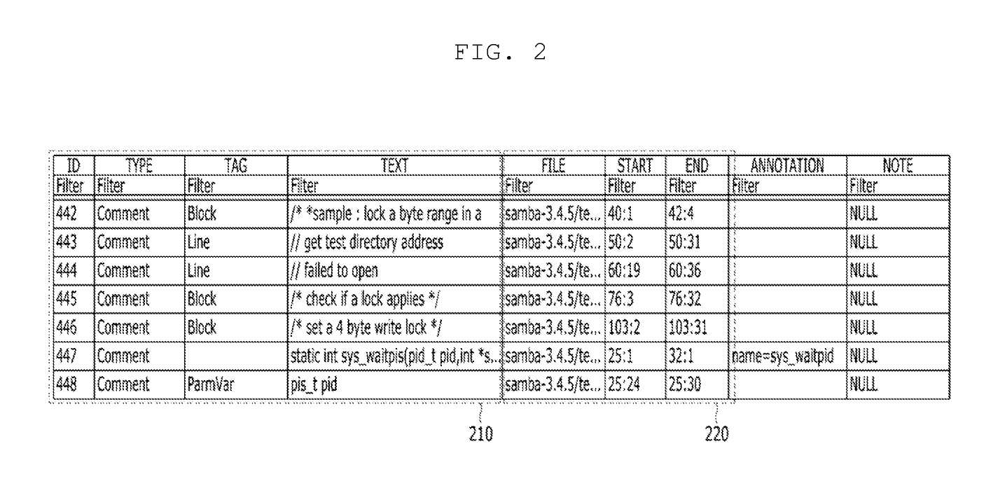

FIG. 2 is an diagram illustrating a database schema including syntax information according to an embodiment of the present disclosure.

Referring to FIG. 2, the database schema may include semantic information 210 and syntax information 220.

The semantic information 210 may include information such as, for example, a type, a name, an address, and a value.

The database schema may also include syntax information. For example, the syntax information may include a name of a file where the object of the data to be analyzed is located, and row and column information about the start position and end position of the object to be analyzed. Based on the database schema, information on the detailed position and the range of impact of each symbol may be analyzed.

The software change impact analyzer 120 may analyze additional information about the detailed position and range of impact of each symbol. In order to implement the additional information, the target program may be precisely analyzed at the Abstract Syntax Tree (AST) level and the Lexer level to extract information, and the result of extraction may be recorded in the database and used in analyzing the impact of the variables.

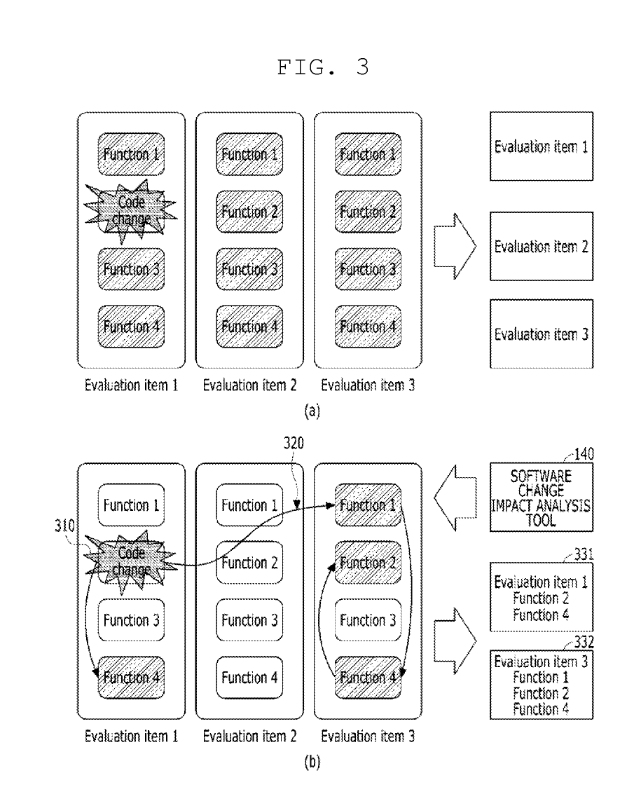

FIG. 3 is a schematic diagram illustrating a method for analyzing impact of software change.

FIG. 3(a) is a schematic diagram illustrating a method for analyzing software change according to an embodiment.

The system may have functions related to evaluation items 1, 2, and 3. The software of evaluation item 1, evaluation item 2, and evaluation item 3 may each include functions 1, 2, 3, and 4.

When the system is inspected according to this method of analysis of software change, for example, the code change of function 2 of evaluation item 1 may be analyzed.

In the case where function 2 of evaluation item 1 is changed, a conventional method of analysis of software modification may perform overall inspection including evaluation item 1, evaluation item 2, and evaluation item 3 regardless of the changed sector. In this case, the efficiency of evaluation efficiency may be deteriorated because even parts not involved in the change are re-evaluated.

Referring to FIG. 3(b), the software change impact analysis tool 140 according to an embodiment extracts a part changed at the time of software modification, and analyzes and extracts parts not directly changed but indirectly affected by the changed part.

The system may have functions related to evaluation items 1, 2, and 3. The software of evaluation item 1, evaluation item 2, and evaluation item 3 may each include functions 1, 2, 3, and 4.

For example, when the software change impact analysis tool 140 inspects the changed system, the changes in functions 2 and 4 of evaluation item 1 and functions 1, 2 and 4 of evaluation item 3 may be analyzed.

The software change impact analysis tool 140 may confirm change of the code of function 2 of evaluation item 1. Direct change of the system by the changed code may be referred to as direct change 310.

When function 2 of evaluation item 1 undergoes direct change 310, the code of function 4 of evaluation item 1 and function 1 of evaluation item 3 may undergo indirect change 320 because of the change in function 2 of evaluation item 1.

The indirect change 320 may refer to a change impacted by the direct change 310.

When function 1 of evaluation item 3 is indirectly changed, function 4 of evaluation item 3 may be indirectly changed because of the change in function 1 of evaluation item 3.

When function 4 of evaluation item 3 is changed, function 2 of evaluation item 3 may be indirectly changed because of the change in function 4 of evaluation item 3.

Once the range of impact is analyzed by the software change impact analysis tool 140, the report generation unit 130 may output the impact of change on function 2 and function 4, which are a part 331 of evaluation item 1.

The report generation unit 130 may output the impact of change on function 1, function 2, and function 4, which are a part 332 of evaluation item 3.

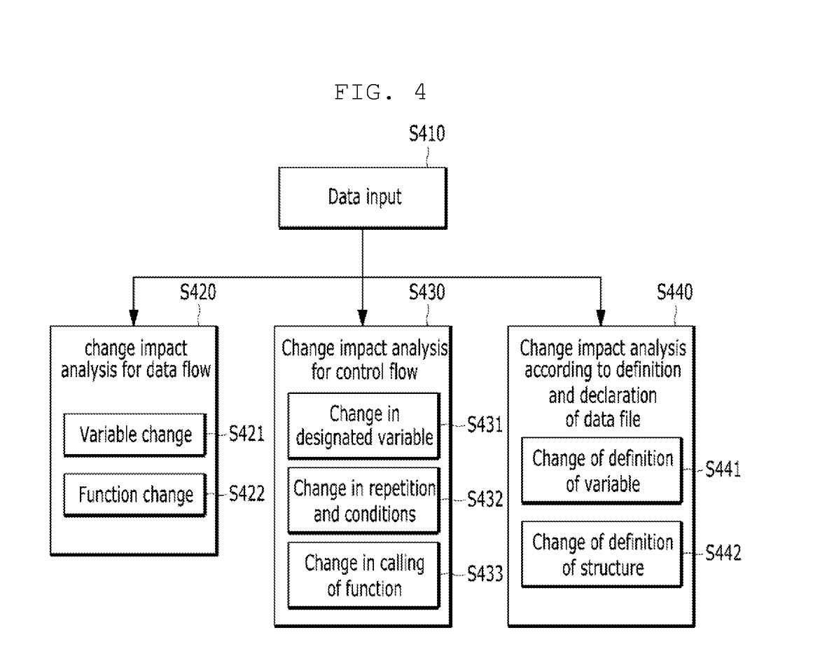

FIG. 4 is a flowchart illustrating analysis of impact of change for each type of change according to an embodiment of the present disclosure.

When the data is input, at S410, the software change impact analyzer 120 may perform analysis according to the type of change.

The type of change includes, at S420, analysis of impact of change for data flow, at S430, analysis of impact of change for control flow, or at S440, analysis of impact of change according to definition and declaration of a data file.

Analysis according to the type of change is a technique of analyzing the ripple effect of the change by analyzing definition and use of the data variable. It is also possible to define general global variables or functions and to perform impact analysis for indirect recursion, not explicit calls by the usage relationship between the global variables or functions and the pointer variables.

The analysis of impact of change for the data flow includes, at S421, analysis of impact of change of variable and, at S422, analysis of impact of change in function.

The analysis of impact of change for the control flow at S430 includes analyzing an impact according to a designated variable, analyzing an impact according to repetition and conditions, and analyzing an impact according to calling of a function.

In analyzing the impact according to the designation variable, the impact according to a designated variable in the corresponding syntax is analyzed, at S431, based on the “for,” “while,” “do,” and “switch” conditions.

In analyzing the impact according to the repetition and the conditions, the impact according to variables designated in a loop or conditional statement including the corresponding syntax in the default conditions of break, continue, and case is analyzed at S432.

In analyzing the impact according to calling of a function, the impact according to change is analyzed, at S433, for an assignment statement in which the function “return” is used, according to the analysis conditions for a relation between calling of the function and the “return”.

The analysis of impact of change according to the definition and declaration of a data file includes analyzing, at S440, the impact according to change of definition of a variable and analyzing the impact according to change of definition of a structure.

In analyzing the impact according to change of definition of the variable, when definition of the variable is changed, the change impact is analyzed, at S441, according to the position and type of the variable.

In analyzing the impact according to change of definition of the structure, the impact of change is analyzed, at S442, in consideration of field change when definition of the structure and the union structure is changed. When, for example, the item “enum” is changed, the impact of change depending on the part where the enum is used is analyzed in the analysis of impact of change according to definition and declaration of the data file.

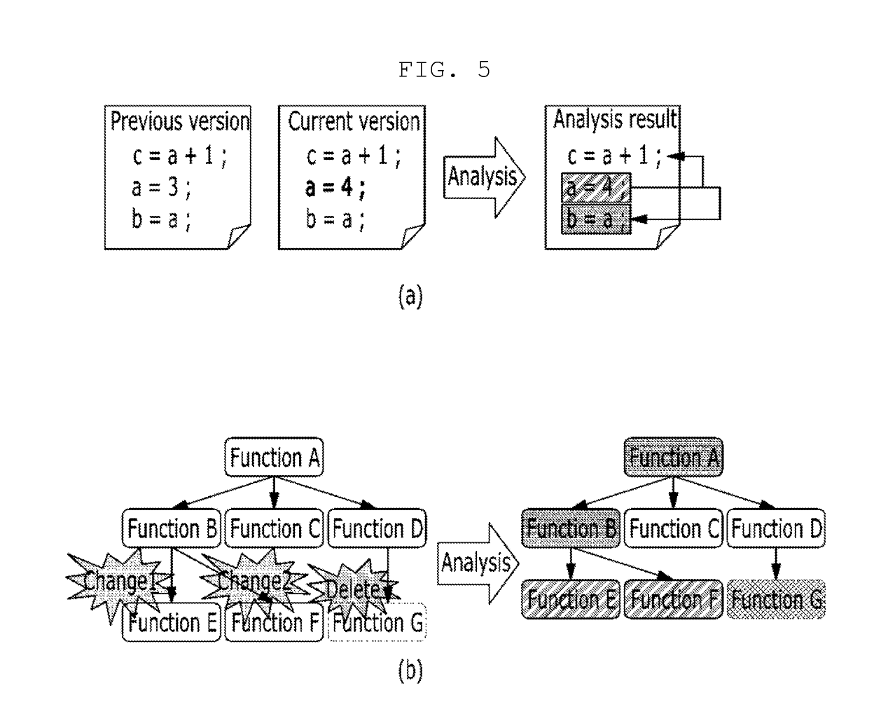

FIG. 5 is a schematic diagram illustrating analysis of impact of change for a data flow according to an embodiment of the present disclosure.

FIG. 5(a) is a schematic diagram illustrating a process of analyzing an impact of a change in a variable according to an embodiment of the present disclosure.

Referring to FIG. 5(a), the source code of a previous version and the source code of the current version are input to the software change impact analyzer 120 as input data.

The source code of the previous version may include, for example, c=a+1 on the first line, a=3 on the second line, and b=a on the third line. The current version of the source code may include c=a+1 on the first line, a=4 on the second line, and b=a on the third line.

The software change impact analyzer 120 compares the previous version and the current version and outputs the result of analysis through the process of variable change impact analysis.

The variable c on the first line is the sentence before the change of the variable a, and has no effect on the variable c.

On the basis of the result of this analysis, when the variable a of the second line changes from 3 to 4, it is analyzed that the variable a of the second line is directly changed.

On the third line impacted by the second line, the variable b is changed to a sentence after change of the variable a of the second line, and the variable a is impacted by the variable b. At this time, the variable b on the third line is analyzed as being indirectly changed.

The process of analyzing the impact of change in variable may improve the accuracy of impact analysis through reachability analysis.

FIG. 5(b) is a schematic diagram illustrating a process of analyzing an impact of change in a function according to an embodiment of the present disclosure.

Referring to FIG. 5(b), in the process of analyzing the impact of change in the function change, the impact of change such as direct change, indirect change, and deletion of the software is analyzed.

In the analysis of impact of change in function, the previous version and the current version is compared. When function E and function F are changed and function G is deleted through the comparison, it is analyzed that change of function E and function F is direct change.

When function E and function F are changed, it is analyzed that function E and function B, which is an upper function of function E, are indirectly changed since they are impacted by function E and function F.

In addition, since function A is impacted by change of function B, function A is also analyzed as being indirectly changed.

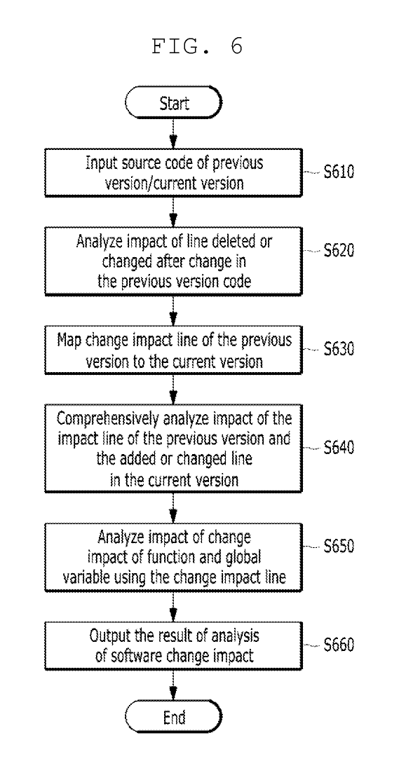

FIG. 6 is a flowchart illustrating an analysis execution procedure of a software change impact analyzer according to an embodiment of the present disclosure.

Referring to FIG. 6, the software change impact analyzer 120 receives, at S610, from the input unit 110, the source code of the previous version and the source code of the current version to be analyzed.

The change impact analysis plug-in 121 analyzes, at S620, the impact of the line deleted or changed after the change in the previous version code.

The change point analysis module 122 map, at S630, the change impact line of the previous version to the current version.

The change impact analysis module 123 analyzes, at S640, the impact of the impact line of the previous version and the added or changed line in the current version.

The change impact analysis module 123 further analyzes, at S650, the impact of change of the function and the global variable using the change impact line.

The report generation unit 130 outputs, at S660, the result of analysis of the impact of change in software.

The output result of the analysis of the impact of change in software result may be seen in Table 1 below.

TABLE 1

| Analysis target | Analysis result (function unit) | | |
|---|---|---|---|
| System | Change point | Change impact | Irrelevant |
| A | 89 (4.9%) | 142 (7.9%) | 1,573 (87.2%) |
| B | 104 (3.2%) | 728 (22.2%) | 2,446 (74. .6%) |
| C | 36 (1.1%) | 294 (8.8%) | 2,994 (90.1%) |
| D | 56 (5%) | 47 (4.2%) | 1,012 (90.8%) |
| E | 16 (1.4%) | 77 (7%) | 1,012 (91.6%) |
| F | 25 (3.5%) | — | 697 (96.5%) |
| G | 8 (2.7%) | 143 (48%) | 147 (49.3%) |

For example, in the case of system A, as a result of analysis of the source code before and after the improvement, it is found that there are 89 directly changed functions, 142 indirectly impacted functions and 1,573 unaffected functions according to change.

Therefore, when the software change impact analysis apparatus 100 is applied, only a total of 231 functions according to the direct change 310 and the indirect change 320 may be tested to output a result.

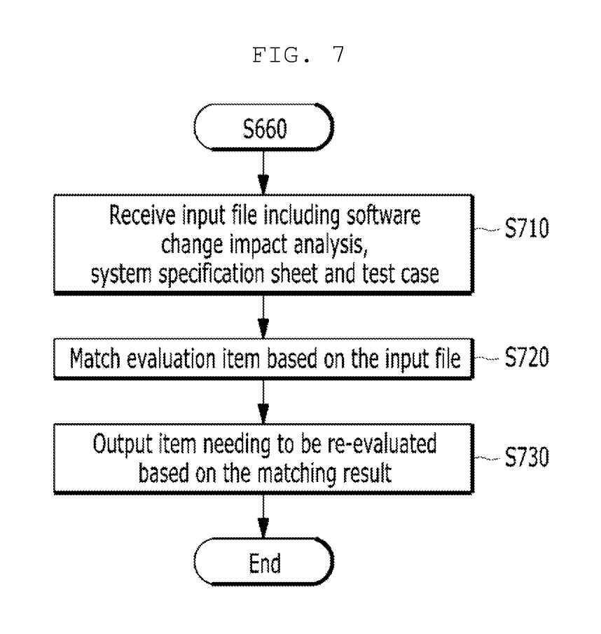

FIG. 7 is a flowchart illustrating an output of analysis of impact of change in software according to an embodiment of the present disclosure.

Referring to FIG. 7, in the evaluation item matching step, an input file including the software change impact analysis, a system specification sheet and a test case is received at S710. The system specification sheet may include a function-specific input/output list. The system specification sheet may be information including function classification and a signal name.

The evaluation items are matched, at S720, based on the input file. This operation includes outputting, at S730, items that need to be reevaluated based on the matching result (S730).

FIG. 8 is a schematic diagram illustrating an evaluation item matching unit of a software change impact analyzer according to an embodiment of the present disclosure.

FIG. 8 shows examples of files input to and output from the evaluation item matching unit 125.

The software analysis result 810 is a list of parts that are shown to have been changed after the analysis of impact of change in software. The impact of the change is indicated. The change and the impact of the change may include variables and functions.

The function-specific input/output list 820 is a list of function-specific input and output signals and parameters of a predetermined form of the vehicle-specific system.

For example, the function-specific input/output list 820 displays functions related to the lamp and the trunk in a list. The lamp and the trunk may include a signal name, which is a parameter corresponding to the input signal and the output signal.

The signal name of the lamp input signal, for example, includes C_AstDrsw and C_DrvDrSw. The signal name of the lamp output signal is L_Lamp_OUT. The signal name of the trunk input signal includes C_TrunkSW and b_BAState. The signal name of the trunk output signal is C_TrunkRly.

The evaluation item list 830 is a function-specific test case for system evaluation. The evaluation item list 830 displays evaluation items about the lamp and the trunk in a list.

The evaluation items about the lamp may include, without limitation, Lamp Test Case 1, Lamp Test Case 2, and Lamp Test Case N. The evaluation items about the trunk include Trunk Test Case 1, Trunk Test Case 2, and Trunk Test Case N. The number of evaluation items in the evaluation item list 830 may be changed according to the system.

The evaluation item matching unit 125 analyzes the result of the software analysis, the function-specific input/output list 820 and the evaluation item list 830 as input data, and extracts an evaluation item 840 that is required to be re-evaluated.

Evaluation items that need to be re-evaluated may include Trunk Test Case 1 and Trunk Test Case 2.

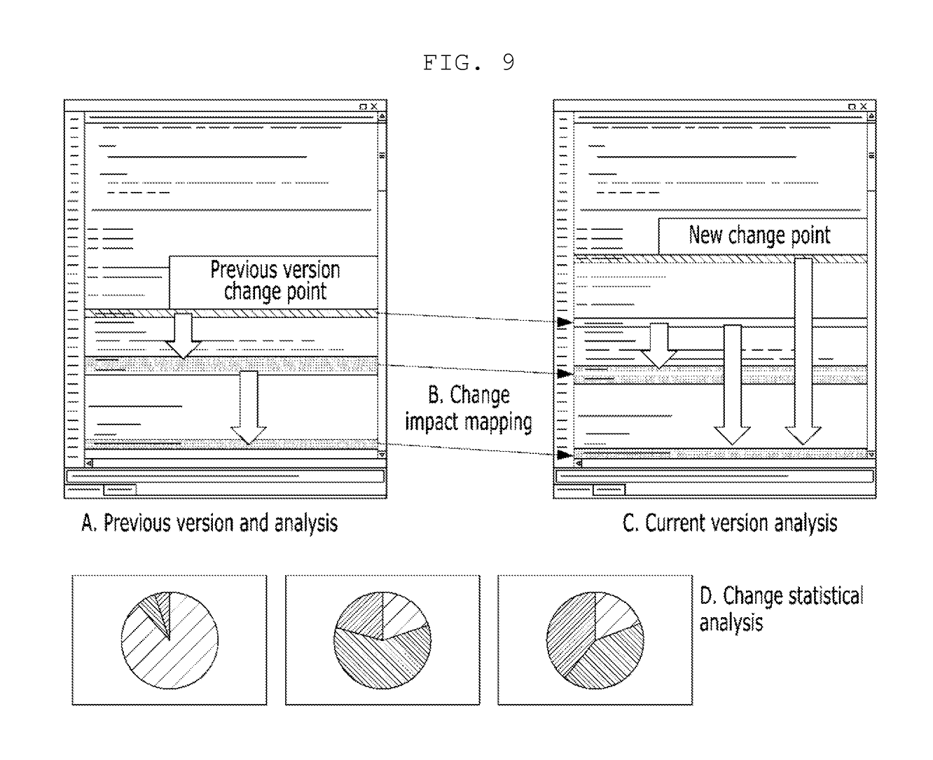

FIG. 9 is a schematic diagram illustrating an analysis execution procedure of a software change impact analyzer according to an embodiment of the present disclosure.

Referring to FIG. 9, the software change impact analyzer 120 receives, from the input unit 110, the source code of the previous version and the source code of the current version to be analyzed as analysis targets.

The change impact analysis plug-in 121 analyzes the impact of a line deleted or changed after the change in the previous version code. Using the change impact analysis plug-in 121, the change point of the previous version is output as an analysis result.

At this time, if there is a direct change according to code change in the previous version, the impact analysis plug-in 121 displays the directly changed part. If there is an indirect change in the source code of the previous version due to a direct change, the indirectly changed part is displayed.

The change point analysis module 122 maps the change impact line of the previous version to the current version.

The change impact analysis module 123 analyzes the impact of the impact line of the previous version and the added or changed line in the current version. The source code of the current version mapped by the change point analysis module includes the change point of the previous version. The part indicated by the direct change are marked in one color, e.g., red. The part indicated by the direct change is marked in a different color, e.g. orange yellow.

At this time, if there is a direct change according to the code change in the source code of the current version, the directly changed part may be displayed. If there is an indirect change in the source code of the current version due to a direct change, the indirectly changed part may be displayed. The part indicated by the direct change may be marked in red. The part indicated by the indirect change may be marked in yellow.

The change impact analysis module 123 may analyze the impact of the function and the global variable change impact using the change impact line. The analysis result may include basic statistics, functional statistics, and variable statistics.

The report generation unit 130 may output a software change impact analysis result.

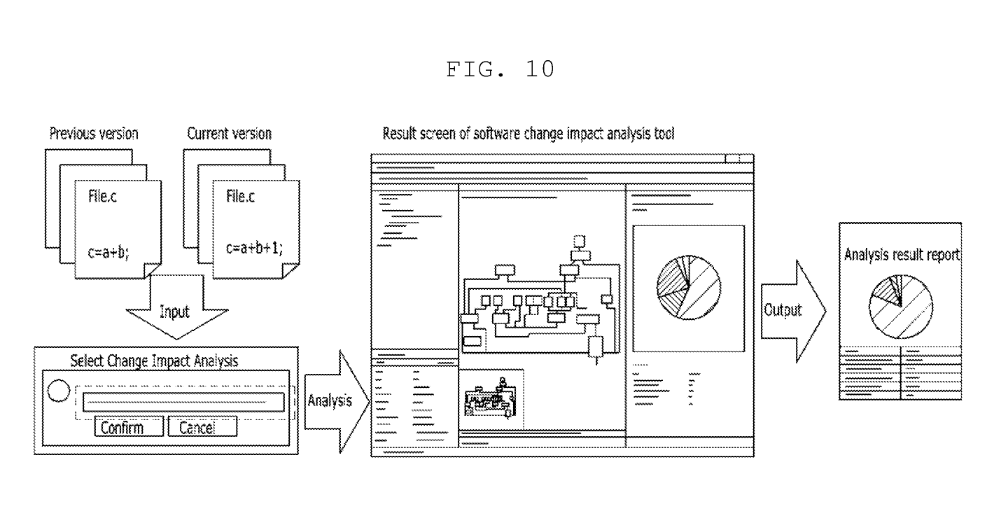

FIG. 10 is a schematic diagram illustrating a flow of analyzing the impact of change in software according to an embodiment of the present disclosure.

Referring to FIG. 10, the software change impact analysis tool 140 receives input data including the source code of the previous version and the source code of the current version from the input unit 110. The source code of the previous version includes c: a+b. The source code of the current version may include c: a+b+1.

When the input data is input, the software change impact analysis tool 140 selects the change impact analysis.

A result screen of the software change impact analysis tool through the change impact analysis is be output.

The result screen of the software change impact analysis tool classifies the analysis result into an analysis target including at least one of a variable, a function, a file, and a line and display the analysis target.

The result screen of the software displays a statistical analysis of change in one area of the result screen. The result screen of the software displays a flowchart of a function in another area of the result screen.

At this time, a part indicated by the direct change in the displayed function is displayed in one color, e.g., red. The part indicated by the indirect change is displayed in a different color, e.g., yellow.

The software change impact analysis tool 140 outputs the result of analysis of impact of the change.

The report generation module 131 generates a report from the result of analysis received from the software change impact analyzer.

The change impact analysis result output module 132 outputs the report received from the report generation module.

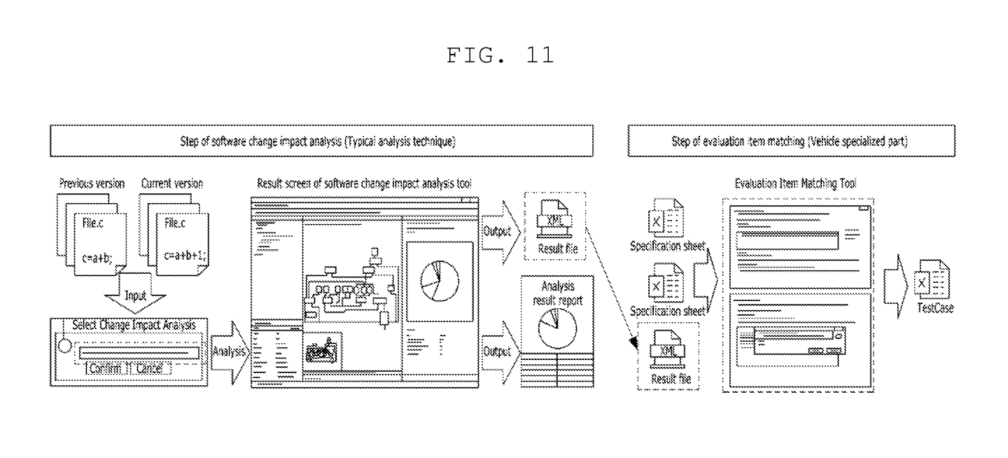

FIG. 11 is a schematic diagram illustrating a flow of matching of an evaluation item according to an embodiment of the present disclosure.

Referring to FIG. 11, since the step of analyzing the impact of change in software is similar to that described with reference to FIG. 10, a description of similar portions will be omitted.

The software change impact analysis tool 140 outputs a result file for the result of analysis of the software change impact. The result file includes a variable list and a function list having a point ay which the change is made and an impact of change generated by the software change impact analysis tool.

The evaluation item matching unit 125 includes the result file as input data. In addition, the evaluation item matching unit 125 includes a specification sheet information and test case information as input data.

The evaluation item matching unit 125 analyzes the evaluation items in the input data including the software analysis result file, the specification sheet, and the test cases using the evaluation item matching tool, and extracts evaluation items that need to be re-evaluated.

The evaluation item matching unit 125 outputs the items that need to be re-evaluated, based on the analysis result of the software change impact.

The method according to an embodiment of the present disclosure may be implemented as a program to be executed on a computer and stored in a computer-readable recording medium. Examples of the computer-readable recording medium include, but are not limited to, ROM, RAM, CD-ROM, magnetic tapes, floppy disks, and optical data storage systems. The computer-readable recording medium may be distributed over a networked computer system so that computer readable code may be stored and executed in a distributed manner. Furthermore, the computer-readable recording medium may be distributed to a computer system connected via a network, and computer-readable code may be stored and executed according to a distributed system. Functional programs, code, and code segments for implementing the method may be easily inferred by programmers in the art to which the present disclosure pertains.

As apparent from the above description, a method and apparatus for analyzing the impact of change in software according to embodiments of the present disclosure may have the following effects.

First, as the apparatus for analyzing the impact of change in software is used, even parts which the developer cannot trace manually may be analyzed.

Second, since the software change impact analysis apparatus is capable of performing analysis on a variable-by-variable basis, accuracy of the analysis may be improved and the evaluation range may be narrowed. Therefore, evaluation efficiency may be enhanced.

Third, when the software is changed, even the changed function and the impact of the change may be evaluated by applying the presently disclosed technology. Therefore, accuracy and reliability may be improved compared to a case when only the changed function is evaluated.

The effects obtainable by the present disclosure are not limited to the above-mentioned effects, and other effects not mentioned herein can be clearly understood by those skilled in the art from the following description.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. A method for analyzing an impact of change in a software using a processing system including at least one processor and at least one memory device operatively connected to the at least one processor and having computer-executable instructions stored therein, the method comprising:
inputting data containing two different source codes;
analyzing, by the at least one processor, the input data by a change type based on a database schema comprising syntax information; and
outputting a result of the analysis for each change type.

2. The method according to claim 1, wherein the syntax information comprises at least one of a name of a file where an analysis object of the data is located, and row and column information about a start position and an end position of the analysis object.

3. The method according to claim 1, wherein the analyzing comprises:
analyzing impact of the change according to a data flow;
analyzing impact of the change according to a control flow; and
analyzing impact of the change according to definition and declaration of a data type.

4. The method according to claim 3, wherein the analyzing impact of the change according to the data flow comprises:
analyzing impact according to a variable change; and
analyzing impact according to a function change.

5. The method according to claim 3, wherein the analyzing impact of the change according to the control flow comprises:
analyzing impact according to a designated variable;
analyzing impact according to repetition and conditions; and
analyzing impact according to calling of a function.

6. The method according to claim 3, wherein the analyzing impact of the change according to definition and declaration of the data type comprises:
analyzing impact according to change in definition of a variable; and
analyzing impact according to change in definition of a structure.

7. The method according to claim 1, wherein the input data comprises a source code of a previous version and a source code of a current version, wherein the analyzing comprises:
analyzing an impact of a line deleted or changed after change in the code of the previous version;
mapping a change impact line of the previous version to a current version;
analyzing an impact of the impact line of the previous version and a line added or changed in the current version; and
analyzing an impact of change of a function and a global variable using the change impact line.

8. The method according to claim 1, wherein the outputting of the result of the analysis for each change type comprises:
classifying the result of the analysis into an analysis object comprising at least one of a variable, a function, a file, and a line; and
classifying the result of the analysis into an item comprising at least one of direct change, indirect change, and no impact, based on the classified analysis unit.

9. The method according to claim 1, further comprising:
an evaluation item matching step of analyzing an item that needs to be re-evaluated, based on the result of the analysis of the impact of the change in the software.

10. The method according to claim 9, wherein the evaluation item matching step comprises:
receiving an input file comprising the result of the analysis of the impact of the change in the software, a system specification sheet and a test case;
matching an evaluation item based on the input file; and
outputting the item that needs to be re-evaluated, based on a result of the matching.

11. A non-transitory computer-readable recording medium having instructions stored thereon, the instructions when executed by a processor cause the processor to perform a method of claim 1.

12. An apparatus for analysis of impact of a change in a software including a processing system including at least one processor and at least one memory device operatively connected to the at least one processor and having computer-executable instructions stored therein, the apparatus comprising:
an inputter configured to input data containing two different source codes;
a software change impact analyzer configured to analyze the input data by a change type based on a database schema comprising syntax information; and
a report generation unit configured to output a result of the analysis for each change type, the result of the analysis comprising the impact of portions of the software directly and indirectly affected by the change in the software.

13. The apparatus according to claim 12, wherein the syntax information comprises at least one of a name of a file where the data is located, and row and column information about a start position and an end position of the data.

14. The apparatus according to claim 12, wherein the software change impact analyzer is configured to:
analyze impact of the change according to a data flow;
analyze impact of the change according to a control flow; and
analyze impact of the change according to definition and declaration of a data type.

15. The apparatus according to claim 14, wherein the software change impact analyzer analyzes impact of the change according to the data flow by:
analyzing impact according to a variable change; and
analyzing impact according to a function change.

16. The apparatus according to claim 14, wherein the software change impact analyzer analyzes impact of the change according to the control flow by:
analyzing impact according to a designated variable;
analyzing impact according to repetition and conditions; and
analyzing impact according to calling of a function.

17. The apparatus according to claim 14, wherein the software change impact analyzer analyzes impact of the change according to definition and declaration of the data type by:
analyzing impact according to change in definition of a variable; and
analyzing impact according to change in definition of a structure.

18. The apparatus according to claim 12, wherein the input unit receives input data comprising a source code of a previous version and a source code of a current version,
wherein the software change impact analyzer comprises:
a change impact analysis plug-in configured to analyze an impact of a line deleted or changed after change in a code of the previous version;
a change point analysis module configured to map a change impact line of the previous version to a current version; and
a change impact analysis module configured to analyze an impact of the impact line of the previous version and a line added or changed in the current version and to analyze an impact of change of a function and a global variable using the change impact line.

19. The apparatus according to claim 12, wherein the report generation unit is configured to:
classify the result of the analysis into an analysis object comprising at least one of a variable, a function, a file, and a line; and
classify the result of the analysis into an item comprising at least one of direct change, indirect change, and no impact, based on the classified analysis unit.

20. The apparatus according to claim 12, further comprising:
an evaluation item matching unit configured to analyze an item that needs to be re-evaluated, based on the result of the analysis of the impact of change in the software.

21. The apparatus according to claim 12, wherein the evaluation item matching unit is configured to:
receive an input file comprising the result of the analysis of the impact of the change in the software, a system specification sheet and a test case;
match an evaluation item based on the input file; and
output the item that needs to be re-evaluated, based on a result of the matching.

22. The method of claim 1, wherein the database schema defines a structure of data, a method of expressing data and relationship between data in a database.

23. The method of claim 1, further comprising outputting the result of the analysis comprising the impact of portions of the software directly and indirectly affected by the change in the software.
